(19) United States
(12) Patent Application Publication
(10) Pub. No.: US 2023/0246165 A1
(43) Pub. Date: Aug. 3, 2023

(54) HIGH-COMPACTION SILICON-CARBON NEGATIVE ELECTRODE PRECURSOR MATERIAL, PREPARATION METHOD THEREFOR, AND HIGH COMPACTION SILICON-CARBON NEGATIVE ELECTRODE MATERIAL PREPARED THEREFROM

(71) Applicant: SHAANXI COAL CHEMICAL INDUSTRY TECHNOLOGY RESEARCH INSTITUTE CO., LTD., Xi'an, Shaanxi (CN)

(72) Inventors: Shifeng YANG, Xi'an, Shaanxi (CN); Xinlong CAO, Xi'an, Shaanxi (CN); Chang' an ZHANG, Xi'an, Shaanxi (CN); Xin XU, Xi'an, Shaanxi (CN); Mengyao XUE, Xi'an, Shaanxi (CN); Zhanyuan TIAN, Xi'an, Shaanxi (CN)

(21) Appl. No.: 17/918,716

(22) PCT Filed: Apr. 14, 2021
(86) PCT No.: PCT/CN2021/087244

§ 371 Date: Oct. 13, 2022

(30) Foreign Application Priority Data
Apr. 14, 2020 (CN) 202010291253.4

(51) Int. Cl. H01M 4/36; H01M 4/38; H01M 4/583; H01M 4/04

(52) U.S. Cl. CPC H01M 4/364; H01M 4/386; H01M 4/583; H01M 4/0471; H01M 2004/027

(57) ABSTRACT

A high compaction silicon carbon negative electrode precursor material with a saddle-like structure, a preparation method therefor and a silicon carbon negative electrode material prepared therefrom. The silicon carbon negative electrode precursor material is formed by compounding nano silicon and a carbon material, and the particles of the high compaction silicon carbon negative electrode precursor material have one or more recessed curved surfaces, and at least one of the curves constituting the curved surface is a parabola with a focus outside of the particles. The precursor material has high mechanical strength, and the particle structure keeps intact after rolling, and can be made into an electrode sheet with high compaction and high density.

### FIELD OF THE PRESENT DISCLOSURE

The present disclosure pertains to the technical field of secondary batteries, and particularly relates to a high compaction silicon carbon negative electrode precursor material, a preparation method thereof and the high compaction silicon carbon negative electrode material prepared therefrom.

### BACKGROUND OF THE PRESENT DISCLOSURE

Silicon material has the advantages of ultra-high theoretical specific capacity (Li₂₂Si₅, 4200 mAh/g), abundant reserves and low cost, which has become the key point and hot spot of development of electrode materials for lithium ion batteries. However, the large volume expansion (up to 300%) of silicon materials during charging and discharging is prone to cause silicon particle breakage or pulverization, electrical contact failure and rapid deterioration of battery performance, which seriously restricts the industrialization of silicon negative electrode materials. In order to inhibit and alleviate the volume expansion of the silicon cathode, it is mainly improved by the nano-silicon and the construction of silicon carbon composite material with loose and porous structure and good particles dispersion. In silicon carbon composite materials, carbon materials can inhibit the agglomeration of nano silicon and buffer the volume expansion of silicon; at the same time, the good electrical conductivity of the carbon material can effectively improve the electrical contact after the volume expansion of silicon, thereby effectively improving the electrochemical performance of the material. However, the low apparent density and compacted density of the current porous silicon carbon negative electrode materials are not advantageous for obtaining battery electrode sheets with high surface loading. In addition, when the electrode sheets are rolled at the later stage, the porous structure is easily damaged, the specific surface is dramatically increased, and the electrochemical performance is seriously attenuated, which is difficult to meet the needs of commercial lithium ion battery applications. There is therefore a need to develop high performance silicon carbon composite materials with high compacted density.

CN 105932245B provides a high compacted density silicon carbon negative electrode material, and in this invention, it uniformly disperses nano silicon with a particle size of less than 200 nm and a uniform coating layer on the surface thereof inside a porous silicon carbon sphere, and the silicon carbon composite material has a porous spherical structure. CN 109360946B provides a preparation method of a high compacted density silicon carbon negative electrode material, specifically solving the problems of uneven and incomplete surface carbon coating through multiple mixing and coating processes, and solving the problem of difficulty in increasing the compacted density of the silicon carbon cathode. The silicon carbon composite material developed at present can be defined as particles composed of a core layer and a coating layer, wherein the core layer is a composite material with nano silicon and carbon, i.e., a precursor material for a silicon carbon cathode, uniformly dispersed, and a lower specific surface area is obtained through a subsequent coating process so as to prepare a silicon carbon composite negative electrode material which can be for commercial application. In the above-mentioned patent documents, besides optimizing the dispersion and compounding of nano silicon and carbon, the work of increasing the compacted density of the material focuses on the optimization process of the coating layer, the coating layer prepared by the process has a structural reinforcement effect on the core layer, but can only improve the mechanical properties of the finished material to a some extent; since the mechanical properties of the core layer material are not substantially improved, the core layer is difficult to sustain the strong pressure transmitted by the coating layer during the manufacturing process of electrode sheets with higher compacted density, and structural damage or even collapse will still occur.

### SUMMARY OF THE PRESENT DISCLOSURE

In the prior art, the silicon carbon material is prone to particle breakage and composite structure collapse in the rolling process of battery electrode sheet manufacturing process. The present disclosure provides a high compaction silicon carbon negative electrode precursor material having a saddle-like structure, a preparation method thereof, and a prepared silicon carbon negative electrode material, the precursor material having high mechanical strength and highly compacted density, contributing to the improvement of cycle performance and energy density of a battery.

The objectives of the present disclosure may be accomplished by the following technical solution:

Provided is a high compaction silicon carbon negative electrode precursor material, wherein the high compaction silicon carbon negative electrode precursor material is compounded from nano silicon and a carbon material, and the particles of the high compaction silicon carbon negative electrode precursor material have one or more recessed curved surfaces, and at least one of the curves constituting the curved surface is a parabola with a focus outside of the particles.

Preferably, the content of the nano silicon in the high compaction silicon carbon negative electrode precursor material is 25.0 wt. % to 85.0 wt. %.

A preparation method of a high compaction silicon carbon negative electrode precursor material, comprising steps of:

step 1, dispersing a nano silicon and a carbon source in a solvent, and stirring until uniform to provide a suspension; the particle size of the nano silicon is 50 to 200 nm, and the oxygen content in the nano silicon is 8.0 wt. % to 25.0 wt. %;

step 2, spray granulating the suspension, wherein the spray inlet temperature is 150 to 190° C., and the outlet temperature is 75 to 100° C.;

step 3, calcining the spray-granulated sample under an inert atmosphere to provide a high compaction silicon carbon negative electrode precursor material.

Preferably, in step 1, the carbon source is one of starch, citric acid, phenolic resin, pitch and polyvinylpyrrolidone, or a combination thereof.

Preferably, the carbon source further comprises graphite and/or carbon fibers.

Preferably, in step 1, the solvent is one or a combination of water, ethanol, tetrahydrofuran and isopropanol.

Preferably, in step 1, the stirring time is 0.1 to 3.0 h.

Preferably, in step 3, the calcination temperature is 600 to 1100° C. and the calcination time is 2.0 to 8.0 h.

Provided is a high compaction silicon carbon negative electrode material, wherein the high compaction silicon carbon negative electrode precursor material is provided by a carbon coating process, and the particles of the high compaction silicon carbon negative electrode material have one or more recessed curved surfaces, and at least one of the curves constituting the curved surface is a parabola with a focus outside of the particles.

Compared with the prior art, the present disclosure may have the following beneficial technical effects:

In the present disclosure, it mainly improves the mechanical properties and compacted density of the material in respect of the external shape design of the material particles. From the viewpoint of structural mechanics, the silicon carbon negative electrode precursor material of the present disclosure has a recessed curved surface including a parabola with a focus outside of the particle, and this particle shape is similar to that of a hyperbolic parabola, which gives the particle an innate ultra-high mechanical strength. As shown in FIG. 1, the hyperbolic paraboloid has two parabolas with an upward opening, which are shaped much like a saddle, so called saddle surface. The curved surface of such shape has high stability and load-bearing property in physical structure. It can not only withstand pulling, but also withstand compression, thereby forming a delicate balance between pressure and tension, and the structure is exceptionally stable even if the structural material is thin. This structure has been widely used in the field of architecture, such as the San Vicente de Paul Chapel, the Scotiabank Saddledome in Canada, the Los Manantiales Restaurant, the 2012 London Olympic Interior Cycling Hall, etc. Even a curved surface structure has only one parabola opening upwards and one straight line, load-bearing property is good. Under the overload stress, the cracks only appear in the middle stress line direction, and will not propagate to other directions. Based on this parabolic structure with an upward opening, the present disclosure provides a high compaction silicon carbon precursor material of a saddle-like shape. The high compaction silicon carbon negative electrode precursor material of the present disclosure has high mechanical strength, and the particle structure keeps intact after rolling, thereby providing an electrode sheet with high compacted density.

There are two technical points in the preparation of the saddle-like surface-shaped particles: 1) the nano silicon particles with the size of 50 to 200 nm have good dispersion and fluidity; 2) in the “spray-drying” (instantaneous high temperature) stage, carbon sources with higher viscosity and flexural properties, such as starch, citric acid, phenolic resin, pitch and polyvinylpyrrolidone, etc. are selected, and spherical droplets composed of nano silicon and carbon sources can be smoothly “shaped” by capillary mechanism, thereby facilitating the formation of recessed curved surface shape. This curved surface structure gives the particles a high mechanical strength, so that a high compacted density of the material in the electrode sheets is provided. The synthesis method provided by the present disclosure may have the advantages of being simple and efficient, easy to implement on a large scale, which has wide application prospect. In addition to the design of the external shape of the saddle-like surface morphology particles, the process of the present disclosure also optimizes the design of the internal structure of the particles to improve the mechanical properties and compacted density of the material. To improve the mechanical properties of the internal structure of particles, the uniform dispersion and compact composite structure of nano silicon and carbon was prepared. From the perspective of process and technology, 1) it is achieved through spray drying process, specifically the uniform dispersion of silicon and carbon source in the form of liquid droplets and achieving the compact combination of silicon and carbon source by means of instant drying; 2) silicon with an oxygen content of 8 wt. % to 25 wt. % is selected, and at this oxygen content, the oxide layer on the surface of the nano silicon can effectively enhance the recombination between silicon and carbon source through chemical bonding effects, and at the same time reduce the effect of too low initial efficiency of silicon carbon precursor material caused by the oxide layer (SiOx) at too high oxygen content.

The silicon carbon negative electrode material prepared by using the high compaction silicon carbon negative electrode precursor material of the present disclosure has high mechanical strength, and it is found by comparison that the mechanical strength of the silicon carbon negative electrode material in the present disclosure may be higher than that of the silicon carbon negative electrode material prepared by using non-saddle-like surface morphology particles.

### BRIEF DESCRIPTION OF THE DRAWINGS

FIG. 1 is a schematic diagram of hyperbolic paraboloid (“saddle surface”);

FIG. 2 is an electron micrograph of the silicon carbon precursor material of Example 1: (a) primary particles; (b) 120 MPa tableted particles;

FIG. 3 is an electron micrograph of the material in Example 2: (a) a silicon carbon precursor material; (b) a silicon carbon precursor material electrode sheet having a compacted density of 1.65 g/cm³; (c) a silicon carbon negative electrode material, (d) a silicon carbon negative electrode material electrode sheet having a compacted density of 1.70 g/cm³;

FIG. 4 is a first charge-discharge curve for the silicon carbon precursor material of Example 2;

FIG. 5 is an electron micrograph of the silicon carbon precursor material of Example 3: (a) primary particles; (b) 60 Mpa tableted particles;

FIG. 6 is a scanning electron micrograph of the silicon carbon precursor material of Example 4; (a) primary particles; (b) 120 MPa tableted particles;

FIG. 7 is an electron micrograph of the material in the comparative example: (a) silicon carbon precursor material particles; (b) 120 MPa tableted silicon carbon precursor material particles; (c) a silicon carbon negative electrode material electrode sheet having a compacted density of 1.65 g/cm³.

### DESCRIPTION OF THE EMBODIMENTS

The present invention will now be described in further detail with reference to specific examples, which are intended to be illustrative rather than restrictive.

It is considered in the present disclosure that increasing the mechanical strength and compacted density of the silicon carbon negative electrode precursor material (i.e., the core layer) is useful for the preparation of a high compacted density silicon carbon composite negative electrode material. In preparation of high compaction silicon carbon precursor material, in addition to achieving good dispersion and recombination of nano silicon and carbon, the particle shape of the precursor material is also a key factor affecting the compacted density.

The present disclosure provides a high compaction silicon carbon negative electrode precursor material of a saddle-like shape and a preparation method thereof, which improves the mechanical properties and the compacted density of the material from the aspects of the inside of the particle and the shape of the outside of the particle respectively: on the one hand, uniform dispersion and closely compounding of nano silicon and carbon are achieved through spray drying process; on the other hand, by reasonably controlling the particle size and oxygen content of nano silicon, the carbon source with good thermoplasticity is preferentially selected to produce particles containing curved surfaces with high mechanical strength, so that high compacted density can be provided for the material in the electrode sheet.

The specific solutions are as follows:

The preparation method of a high compaction silicon carbon negative electrode precursor material according to the present disclosure may comprise the following steps:

Step 1, the nano silicon and the carbon source were dispersed in a solvent, then stirred uniformly to prepare a suspension, the stirring time being 0.1 to 3.0 h, preferably 0.5 to 1.0 h;

Step 2, the prepared suspension was granulated by using a centrifugal or two-fluid spray drying device, wherein the spray inlet temperature was 150 to 190° C., and the outlet temperature was 75 to 100° C.;

Step 3, the spray-dried sample was calcined under an inert atmosphere at a calcination temperature of 600 to 1100° C. for a calcination time of 2.0 to 8.0 h to provide a high compaction silicon carbon negative electrode precursor material.

In step 1, the nano silicon has a particle size of 50 to 200 nm and an oxygen content of 8.0 wt. % to 25.0 wt. %. The carbon source may be one or a combination of starch, citric acid, phenolic resin, pitch, and polyvinylpyrrolidone, and may also include graphite and/or carbon fibers. The solvent is one of water, ethanol, tetrahydrofuran and isopropanol, or a combination thereof.

In step 3, the inert atmosphere can be one of nitrogen, argon, or a combination thereof.

The high compaction silicon carbon negative electrode precursor material obtained by the above-mentioned method is formed by uniformly dispersing and closely compounding two components of nano silicon and carbon, wherein the particles of the precursor material have one or more recessed curved surfaces, and at least one of the curves constituting the curved surfaces is a parabola with a focus outside of the particles; the content of nano silicon in the precursor material is 25.0 wt. % to 85.0 wt. %, and the carbon may be graphite & pyrolytic carbon, carbon fiber & pyrolytic carbon or pyrolytic carbon.

The high compaction silicon carbon negative electrode precursor material is treated by a subsequent coating process to provide a silicon carbon negative electrode material, which can be used for a commercial lithium ion battery.

### Example 1

S1, 70 g of nano silicon with a particle size of 200 nm and an oxygen content of 15%, 20 g of graphite, 10 g of pitch and 5 g of citric acid were dispersed in ethanol, uniformly stirred to prepare a suspension, and the stirring time was 0.5 h;

S2, the prepared suspension was granulated by using a centrifugal spray drying device, wherein the spray inlet temperature was 175° C., and the outlet temperature was 80° C.;

S3, the spray-dried sample was calcined under a nitrogen atmosphere at a calcination temperature of 1100° C. for a calcination time of 2.0 h to prepare a high compaction silicon carbon negative electrode precursor material, and the TG and CHONS test results showed that the content of nano silicon in the material was 75.0%.

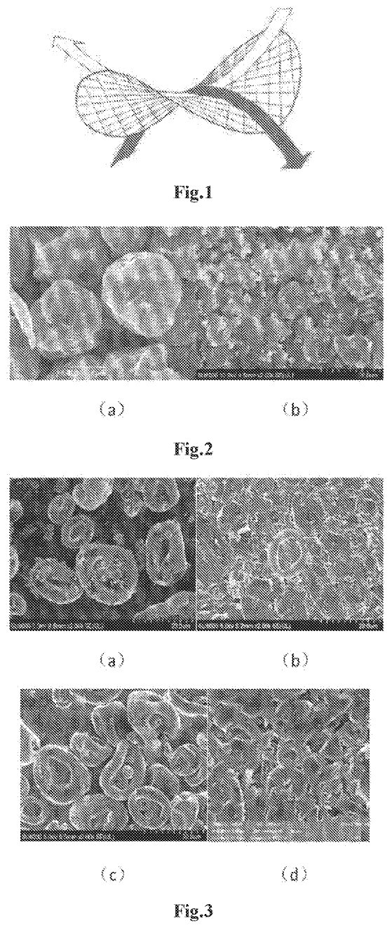

It is apparent from FIG. 2 (a) that the particles prepared in the example have a curved surface structure, and the focus of the parabola constituting the curved surface is outside of the particles. When a pressure of 120 MPa was applied to the material using a powder tablet press, as shown in FIG. 2 (b), most of the particles remained structurally intact and only a few particles were structurally broken.

### Example 2

S1, 80 g of nano silicon with a particle size of 100 nm and an oxygen content of 25%, 35 g of a phenolic resin, and 10 g of pitch were dispersed in a mixed solvent of ethanol and isopropanol, stirred until uniform to prepare a suspension, and stirred for 0.5 h;

S2, the prepared suspension was granulated by using a two-fluid spray drying device, wherein the spray inlet temperature was 190° C., and the outlet temperature was 75° C.;

and S3, the spray-dried sample was calcined under a nitrogen atmosphere at a calcination temperature of 900° C. for a calcination time of 5.0 h to prepare a high compaction silicon carbon negative electrode precursor material.

As shown in FIG. 3 (a), the material prepared in the example had a recessed bowl-like morphology with good curved surface structure. The silicon carbon negative electrode precursor material was mixed with graphite G1, conductive carbon black SP, CMC, SBR in a ratio of 9:91:2:2:4, which was vigorously stirred in deionized water to prepare a uniformly mixed slurry, and then the slurry was uniformly coated on a copper foil current collector and dried in an oven at 80° C. for 10 h to prepare an electrode sheet. As shown in FIG. 3 (b), the particle structure kept intact after rolling the electrode sheets at a compacted density of 1.65 g/cm³.

Mixing the high compaction silicon carbon precursor material prepared in Example 2 with pitch in a mass ratio of 90:10, and then performing a high-temperature treatment in a nitrogen atmosphere, specifically holding the temperature at 600° C. for 3 h and holding the temperature at 900° C. for 2 h, so as to prepare a silicon carbon negative electrode material having a pitch pyrolytic carbon coating layer. As shown in FIG. 3 (c), the silicon carbon negative electrode material retains the saddle-like topographical features of the silicon carbon precursor material. The electrode sheet was made in the same manner as the silicon carbon precursor, and as shown in FIG. 3 (d), the particle structure of the electrode sheet of the silicon carbon negative electrode material kept intact after rolling at a compacted density of 1.70 g/cm³. It can be seen that after the high compaction silicon carbon precursor material is coated with pyrolytic carbon, the compacted density of the electrode sheet increases to some extent, which is consistent with the effect of the conventional coating layer design on the compacted density of the material.

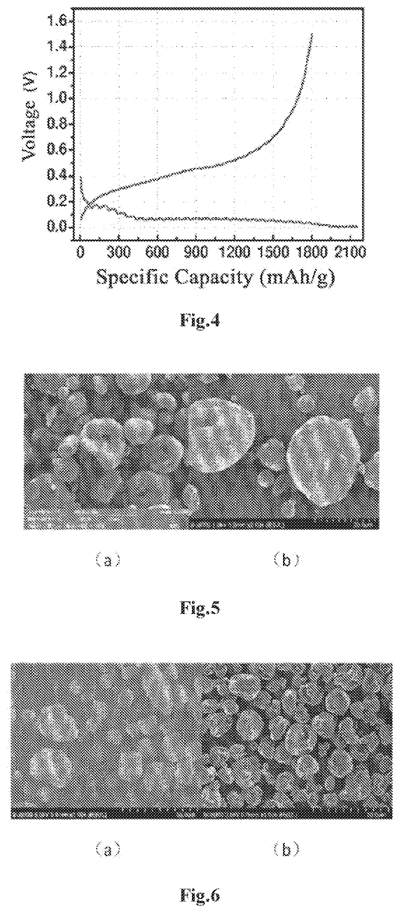

The silicon carbon negative electrode precursor material was mixed with conductive carbon black SP, CMC, SBR in a ratio of 90:2:2:4, which was vigorously stirred in deionized water to prepare a uniformly mixed slurry, and then the slurry was uniformly coated on a copper foil current collector and dried in an oven at 80° C. for 10 h to prepare an electrode sheet, and cutting into circular electrode sheets with a diameter of 10 mm. A button cell was assembled in an argon-protected glovebox using a lithium metal sheet as a positive electrode, a PP/PE/PP microporous membrane (Celgard 2400) as a separator, and 1.15 mol/L LiPF₆ (a solvent is a mixture of ethylene carbonate, dimethyl carbonate and diethyl carbonate in a volume ratio of 1:1:1) as an electrolyte solution to perform charge-discharge tests. As shown in FIG. 4, the first charge specific capacity of the silicon carbon negative electrode precursor material can reach 1785.2 mAh/g, and the first efficiency can reach 82.3%. TG and CHONS show that the content of nano silicon in the material is 85.0 wt. %, and the capacity of nano silicon is close to 2100 mAh/g.

### Example 3

S1, 30 g of nano silicon with a particle size of 50 nm and an oxygen content of 8%, 70 g of graphite and 45 g of a phenolic resin were dispersed in tetrahydrofuran, and stirred for 0.5 h to prepare a uniform suspension;

S2, the prepared suspension was granulated by using a centrifugal spray drying device, wherein the spray inlet temperature was 180° C., and the outlet temperature was 85° C.;

S3, the spray-dried sample was calcined in an atmosphere with a volume ratio of nitrogen to argon being 8:1, the calcination temperature was 600° C., and the calcination time was 8.0 h, so as to prepare a silicon carbon negative electrode precursor material.

TG and CHONS test results showed that the silicon content in the material was 25.0%. As shown in FIG. 5 (a), the material also has a recessed curved surface structure; the particle structure kept intact at 60 MPa pressure as shown in FIG. 5 (b).

### Example 4

S1, 50 g of nano silicon with a particle size of 100 nm and an oxygen content of 15%, 5 g of carbon fiber, 10 g of starch and 40 g of polyvinylpyrrolidone (PVP k30) were dispersed in tetrahydrofuran, stirred until uniform to prepare a suspension, and the stirring time was 0.6 h;

S2, the prepared suspension was granulated by using a centrifugal spray drying device, wherein the spray inlet temperature was 190° C., and the outlet temperature was 75° C.; and

S3, the spray-dried sample was calcined under an argon atmosphere at a calcination temperature of 900° C. for a calcination time of 4.0 h to prepare a silicon carbon negative electrode precursor material.

As shown in FIG. 6 (a), the material has a plurality of curved surface structures. The particle material still had good structural integrity at a pressure of 120 MPa as in FIG. 6 (b).

### Comparative Example

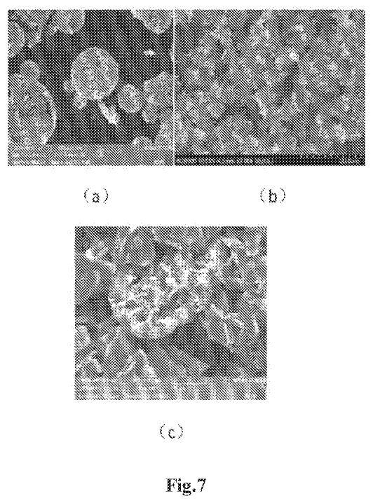

The process conditions were the same as in Example 2, except that the nano silicon oxygen content used was 5%. An electron micrograph of a silicon carbon negative electrode precursor material prepared using nano silicon with an oxygen content of 5% was as shown in FIG. 7 (a), the material was spherical particles. As shown in FIG. 7 (b), all the particles of the material experienced severe particle breakage at 120 MPa pressure. It can be seen that the different oxygen content in the nano silicon causes the difference in particle shape, thereby affecting the mechanical strength of the material. Particles with curved surface structures have higher mechanical strength.

In the same manner as in Example 2, the silicon carbon negative electrode precursor material prepared in Comparative Example was mixed with pitch to prepare a silicon carbon negative electrode material, which was combined with graphite G1 to prepare a silicon carbon negative electrode material. As shown in FIG. 7 (c), particles of the spherical silicon carbon negative electrode material having a pitch coating layer was severely broken at an electrode sheet compacted density of 1.65 g/cm³. It can be seen that the silicon carbon negative electrode precursor material having high mechanical strength is very important for improving the compacted density of the silicon carbon negative electrode material electrode sheet.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A high compaction silicon carbon negative electrode precursor material, wherein the high compaction silicon carbon negative electrode precursor material is formed by compounding nano silicon and a carbon material, and particles of the high compaction silicon carbon negative electrode precursor material have one or more recessed curved surfaces, and at least one of the curves constituting the curved surface is a parabola with a focus outside of the particles.

2. The high compaction silicon carbon negative electrode precursor material according to claim 1, wherein the content of the nano silicon in the high compaction silicon carbon negative electrode precursor material is 25.0 wt. % to 85.0 wt. %.

3. A preparation method of a high compaction silicon carbon negative electrode precursor material, comprising the steps of:
step 1, dispersing a nano silicon and a carbon source in a solvent, and stirring until uniform to provide a suspension; the particle size of the nano silicon is 50 to 200 nm, and the oxygen content in the nano silicon is 8.0 wt. % to 25.0 wt. %;
step 2, spray granulating the suspension, wherein the spray inlet temperature is 150 to 190° C., and the outlet temperature is 75 to 100° C.; and
step 3, calcining the spray-granulated sample under an inert atmosphere, to provide the high compaction silicon carbon negative electrode precursor material.

4. The preparation method of a high compaction silicon carbon negative electrode precursor material according to claim 3, wherein in step 1, the carbon source is one of starch, citric acid, phenolic resin, pitch and polyvinylpyrrolidone, or a combination thereof.

5. The preparation method of a high compaction silicon carbon negative electrode precursor material according to claim 3, wherein the carbon source further comprises graphite and/or carbon fiber.

6. The preparation method of a high compaction silicon carbon negative electrode precursor material according to claim 3, wherein in step 1, the solvent is one of water, ethanol, tetrahydrofuran and isopropanol, or a combination thereof.

7. The preparation method of a high compaction silicon carbon negative electrode precursor material according to claim 3, wherein in step 1, the stirring time is 0.1 to 3.0 h.

8. The preparation method of a high compaction silicon carbon negative electrode precursor material according to claim 3, wherein in step 3, the calcination temperature is 600 to 1100° C. and the calcination time is 2.0 to 8.0 h.

9. A high compaction silicon carbon negative electrode material, wherein the high compaction silicon carbon negative electrode precursor material according to claim 1 is prepared by a carbon coating process, and the particles of the high compaction silicon carbon negative electrode material have one or more recessed curved surfaces, and at least one of the curves constituting the curved surface is a parabola with a focus outside of the particles.
